(19) United States
(12) Patent Application Publication
(10) Pub. No.: US 2008/0184285 A1
(43) Pub. Date: Jul. 31, 2008

(54) MULTI-SELECTION APPARATUS AND METHOD

(75) Inventors: HYUN-MI PARK, Suwon-si (KR); Seung-Eok Choi, Suwon-si (KR); Min-Chul Kim, Seoul (KR); Hyun-Joo Kang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/854,078

(22) Filed: Sep. 12, 2007

(30) Foreign Application Priority Data
Jan. 29, 2007 (KR) 2007-8986

(51) Int. Cl. H04N 7/10

(52) U.S. Cl. 725/32

(57) ABSTRACT

The present invention provides a multi-selection apparatus and method. A multi-selection apparatus includes: a display unit to display a first area in which a plurality of contents are arranged in a line along a predetermined axis and a second area arranged in parallel to the first area; an input unit to receive inputs of user selections; a search unit to search for at least one of the contents to be inserted from the first area into the second area in response to one input signal, via the input unit; a moving unit to insert the at least one content searched from the first area into the second area or to extract the content from the second area in response to another input signal, via the input unit; and a command unit to perform a predetermined operation command on the at least one content inserted into the second area.

### CROSS-REFERENCE TO RELATED APPLICATION

This application claims all benefits accruing under 35 U.S.C. §119 from Korean Patent Application No. 2007-8986, filed on Jan. 29, 2007 in the Korean Intellectual Property Office, the disclosure of which is incorporated herein by reference.

### BACKGROUND OF THE INVENTION

1. Field of the Invention

The present invention relates to a multi-selection apparatus and method, and more particularly, to a multi-selection apparatus and method capable of effectively executing a process of selecting a plurality of contents and a process of performing a single or a few operation commands on the selected plurality of contents through an intuitive and easy user interface scheme.

2. Description of the Related Art

A multi-selection method refers to a method to select a plurality of multimedia contents (hereinafter, referred to as contents) and to perform a single operation command on the selected contents. The multi-selection method enables performance of one operation command on a plurality of contents, while at the same time to improve convenience to users.

FIG. 1 show a typical multi-selection method or a screen of a computer system (PC). As shown in FIG. 1, a user can use a mouse to drag a cursor over a plurality of contents to thereby select the plurality of contents in a screen 10 of a computer system running an operating system (OS) such as Windows Explorer™. The user can use a right button of the mouse, with the contents having been selected, to call up a menu and to perform operation commands thereon, such as delete and copy.

Mobile phones have a simple input method that uses a plurality of directional buttons to support a multi-selection method for some types of contents. Examples of the mobile phones supported multi-selection methods include operation commands such as deletion, selection of a plurality of contents, and repetitiously clicking an OK button.

The kinds of multi-selection methods are greatly affected by a type of input device that is used. Since a mouse can designate an area in selecting multimedia contents by use of a drag of a cursor, the mouse is quite useful for use with the multi-selection method. However, unlike the mouse, a simple input device, such as a remote controller, is not as useful for the multi-selection method. For example, when the user wants to select a plurality of contents to be deleted and/or to extract a specific one of already selected contents, the user would have to search and check all of the contents or the selected contents in the mobile phone and/or the remote controller.

Therefore, a multi-selection method capable of conveniently selecting contents and performing a predetermined operation command thereon is needed.

### SUMMARY OF THE INVENTION

Aspects of the present invention provide a multi-selection apparatus and method capable of effectively executing a process of selecting a plurality of contents and a process of performing a single or a few operation commands on the selected plurality of contents through an intuitive and easy interface scheme.

Additional aspects and/or advantages of the invention will be set forth in part in the description which follows and, in part, will be obvious from the description, or may be learned by practice of the invention.

According to an aspect of the present invention, a multi-selection apparatus includes: a display unit to display a first area in which a plurality of contents are arranged in a line along a predetermined axis and a second area arranged in parallel to the first area; an input unit to receive inputs of user selections; a search unit to search for at least one of the contents to be inserted from the first area into the second area in response to an input signal, via the input unit; a moving unit to insert the at least one content searched from the first area into the second area or to extract the content from the second area in response to another input signal, via the input unit; and a command unit to perform a predetermined operation command on the at least one content inserted into the second area.

According to another aspect of the invention, a multi-selection method includes: displaying a first area in which a plurality of contents are arranged in a line along a predetermined axis and a second area arranged in parallel to the first area; receiving inputs of user selections; searching for at least one of the contents to be inserted from the first area into the second area in response to an input signal, via the inputs of user selections; inserting the at least one content searched from the first area into the second area in response to another input signal, via the inputs of user selections; and performing a predetermined operation command on the at least one content inserted into the second area.

According to an aspect of the present invention, an apparatus includes a display to display, a first area that scrolls along an axis, one or more contents contained in the first area that scrolls along with the first area, and a second area running parallel to the first area and having a capacity to receive contents from the first area via a route running along another axis that is normal to the axis; and a controller to perform one or more operations on the contents received into the second area.

According to an aspect of the present invention, a method of selecting one or more contents using an apparatus to provide a visual display of a first area, a second area, and the one or more contents, includes: scrolling the first area along an axis until a desired one of the one or more contents contained in the first area is aligned with a predetermined marker; inserting a desired one content into the second area via a route running along another axis that is normal to the axis; and performing one or more operations on the desired one content inserted into the second area.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a diagram illustrating a multi-selection method on a Windows Explorer screen of a computer system;

FIG. 2 is a block diagram illustrating a multi-selection apparatus according to an example embodiment of the present invention;

FIG. 3 is a diagram illustrating an image displayed on the multi-selection apparatus according to the example embodiment of the present invention;

FIGS. 4 to 8 are diagrams illustrating a method of inserting a content of a first area into a second area according to the example embodiment of the present invention;

FIG. 9 is a diagram illustrating a method of extracting a content from the second area according to the example embodiment of the present invention; and

FIG. 10 is a flowchart illustrating a multi-selection method according to another example embodiment of the present invention.

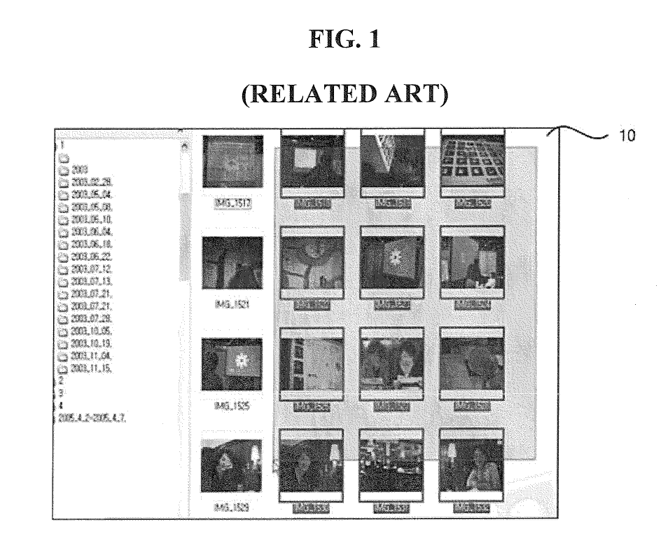

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

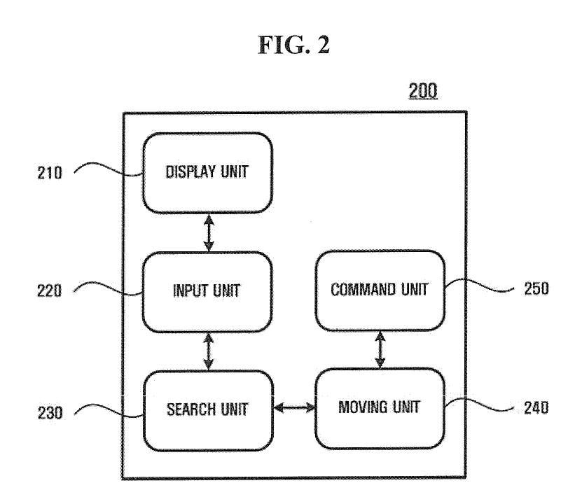

FIG. 2 is a block diagram illustrating a multi-selection apparatus 200 according to an example embodiment of the present invention. The multi-selection apparatus 200 includes a display unit 210, an input unit 220, a search unit 230, a moving unit 240, and a command unit 250. The multi-selection apparatus 200 may be a digital TV, a mobile phone, a personal digital assistant (PDA), a laptop computer, a multimedia player, or other devices. In the following description, a digital TV is used as an example embodiment of the multi-selection apparatus 200. However, it is understood that the multi-selection apparatus 200 may any of the above listed devices or other devices.

In FIG. 2, the display unit 210 displays a first area in which a plurality of contents is arranged in a predetermined axial direction and a second area arranged in parallel to the first area. In various aspects, the plurality of contents may be arranged linearly, though such is not required. The contents include still pictures, moving pictures, audio files, or other files. The still pictures may include a bitmap, JPEG (joint photographic experts group), GIF (graphics interchange format), TIFF (tag image file format) files, or other image files. The moving pictures and/or the audio files may include an MPEG (moving picture experts group), AVI (audio video interleaved file), WMV (Windows media video), DivX code (of DivX Inc.), or other multimedia files. In other aspects, various other files may be the contents, including text files, document files, PDF (portable document format) files, or other file formats.

If the first area is arranged along the horizontal axis of the display unit 210, the second area may be arranged along the upper or lower end of the first area in a parallel arrangement to the first area. In addition, if the first area is arranged along the vertical axis, the second area may be arranged along the right or left edge of the first area in a parallel arrangement to the first area. The display unit 210 may include a module provided with an image display unit, such as a cathode ray tube (CRT), a liquid crystal display (LCD), a light-emitting diode (LED), an organic light-emitting diode (OLED), or a plasma display panel (PDP). In various example embodiments, the display of the first and second areas, and the contents, may be by way of a graphic user interface (GUI).

The input unit 220 receives a predetermined input signal via a selection from a user, and may include an input device to generate the predetermined input signal. For example, in the embodiments of the present invention, the input unit 220 may receive the predetermined input signal transmitted through a directional button of a remote controller. Example embodiments of the input devices include touch pads, trackballs, pointing devices, keyboards, and/or others. Based on the received input signal, the input unit 220 may output an output signal. In example embodiments, the output signal corresponds to the pressed directional button of the remote controller.

The search unit 230 searches for a desired content among predetermined contents for insertion from the first area into the second area. For example, when the user clicks (or presses) a right or left directional button of the remote controller, the search unit 230 searches among the contents within the first area in response to the clicked (or pressed) directional button. The first area can be moved (or scrolled) in the axial (in this case, the horizontal) direction, and the second area can be moved (or scrolled) according to the movement (or scrolling) of the first area.

The moving unit 240 inserts one or more contents (items or selected contents) that have been searched from the first area into the second area, or extracts from the second area, the one or more contents that have been previously inserted into the second area. For example, when one of the contents that have been searched for is disposed in the center of the first area on a screen of a display unit 210 and the user clicks an up button to select one of the searched contents, the moving unit 240 inserts the selected content into the second area. On the other hand, when the user clicks a down button, the moving unit 240 extracts a previously inserted content from the second area. At this point, predetermined signals corresponding to the directional buttons are received through the input unit 220.

In example embodiments, when the selected content of the first area is inserted into the second area, a predetermined space having a sufficient size to include the content may be formed in the second area. In this case, the contents of the first area may be inserted into the second area and arranged therein in the same order in which the contents are arranged in the first area.

In an example embodiment, inserting of the selected content into the second area results in a copy of the selected content to appear or be displayed in the second area. In other example embodiments, inserting of the selected content into the second area results in a representation of the selected content to appear or be displayed in the second area. In the latter cases, the representation may be a thumbnail, a thumbshot, an icon, reduced, enlarged, or modified versions of the selected content, or other similar items. In various example embodiments, a copy or a representation of the selected content that is in the second area may be referred to as a corresponding content.

The command unit 250 performs one or more predetermined operations on the selected contents inserted into the second area. For example, the command unit 250 can collectively delete, copy, share, and/or transmit the contents in the second area. The command for the predetermined operations may be set and executed before or after the selected contents are inserted into the second area.

In this embodiment of the present invention, each of the components shown in FIG. 2, such as a search unit 230, a moving unit 240 and a command unit 250 may be composed of a module. The term “module” may refer to, but is not limited to, a software or hardware component, such as a field programmable gate array (FPGA) or an application specific integrated circuit (ASIC), which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables, noting that alternative embodiments are equally available. In addition, the functionality provided for by the components and modules may be combined into fewer components and modules or further separated into additional components and modules.

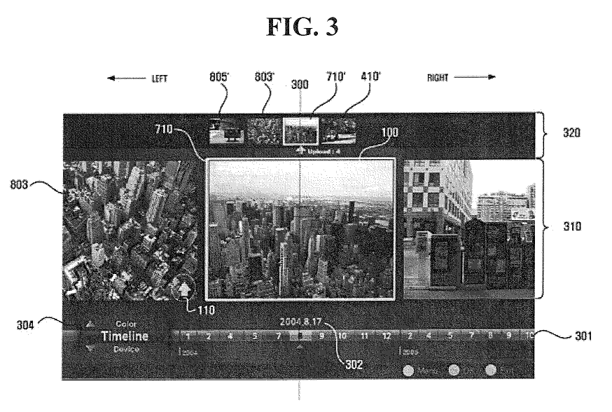

FIG. 3 is a diagram illustrating an image displayed on the multi-selection apparatus according to an example embodiment of the present invention. As shown in FIG. 3, the multi-selection apparatus 200 includes a screen shot displaying a first area 310 in which a plurality of contents (803, 710) are arranged along a predetermined axial direction, and a second area 320 that is arranged in parallel to the first area 310 and displays the corresponding contents (805′, 803′, 710′, 410′) of the selected contents from the first area 310.

In this example embodiment, for example, the first area 310 is arranged along the horizontal axis, and the second area 320 is arranged on the upper side of the first area 310 in parallel arrangement to the first area 310. In this case, each of the first and second areas 310 and 320 can have an arrangement of the contents in a thumbnail form, though not required.

The user uses the right or left button of the remote controller, for example, to search through the contents of the first area 310. When the user clicks the left button, the first area 310 is moved (or scrolled) to the right so that contents in the left of the screen are moved toward the center 300 of the screen. When the user clicks the right button, the first area 310 is moved (or scrolled) to the left so that contents in the right of the screen are moved toward the center 300 of the screen. As a consequence of the respective movements of the first area 310, the contents in the first area 310 are moved toward the center 300 of the screen, so that one of the contents to be inserted into the second area 320 can be disposed at the center 300 of the screen. In the shown embodiment, the center 300 is represented by a line, which is not required. In other example embodiments, the contents in the first area 310, rather than the first area 310 itself, may move or be scrolled.

As shown in FIG. 3, a mask window 100 having a size similar or equal to that of the content in the first area 310 may be provided in the center 300 of the screen in the first area 310. The mask window 100 helps the user to easily check (or determine) whether a predetermined (or desired) content is arranged at the center 300 of the screen as the first area 310 is moved. In the example embodiment shown in FIG. 3, the content 710 is arranged exactly at the center 300 of the screen and is aligned with the mask window 100.

Meanwhile, various identification marks 110 may be displayed in the contents that have been inserted from the first area 310 into the second area 320 or have a corresponding content in the second area 320 so that the user can easily recognize the insertion of the content. The identification marks 110 may include, for example, arrows, highlighted marks, change of color, shading, or size, or other indicia. In the example embodiment shown in FIG. 3, the content 803 (of the first area 310) includes the identification marks 110 to indicated existence of the corresponding content 803′ (in the second area 320).

When a predetermined content (or content) 710 is disposed at the center 300 of the screen in the first area 310, the user can insert the content 710 disposed at the center 300 of the screen into the second area 320. For example, when the user pushes the up button of the remote controller, the content 710 disposed at the center 300 of the screen is inserted into the second area 320.

Preferably, though not required, the content 710 in the first area 310 remains in the first area 310, and is copied to the second area 320. That is, a corresponding content 710′ inserted into the second area 320 is a copy of the content 710 in the first area 310, and can serve as a kind of pointer (or a surrogate). Therefore, to generalize, when a content X in the first area 310 is deleted from a storage space (for example, a memory of the multi-selection apparatus 200), a corresponding content X′ inserted into the second area 320 may also be deleted. Similarly, when a delete operation is performed on the corresponding content X′ in the second area 320, the content X in the first area 310, which is copied to the second area 320, may be deleted or be effectively deleted. However, when the corresponding content X′ in the second area 320 is extracted, no operation command (such as delete or copy) is issued. Therefore, the content X in the first area 310 is maintained in the storage space.

The example embodiment of FIG. 3 further shows that a date of creation 302 of the content 710 selected from the first area 310 may be displayed on the screen of the multi-selection apparatus 200. The date of creation 302 may be information on the data and time of the creation of the content 710, such as the year, month, day, hour, minute, and second thereof. In the shown example embodiment, a timeline 301 may be provided to organize a plurality of the contents according to dates of creation of the contents.

In addition, information on the main color of the content 710 (or a plurality of contents) may be provided through a predetermined menu 304. The main color may be one of the colors included in the content 710 that is distributed over the largest area of the content 710, or may be the average of the colors included in the content 710. For example, when the number of red pixels is the largest in the content 710, the main color may be red. When the number of red pixels is similar to the number of blue pixel, the main color of the content 710 may be violet, which is a mixture of the red and blue.

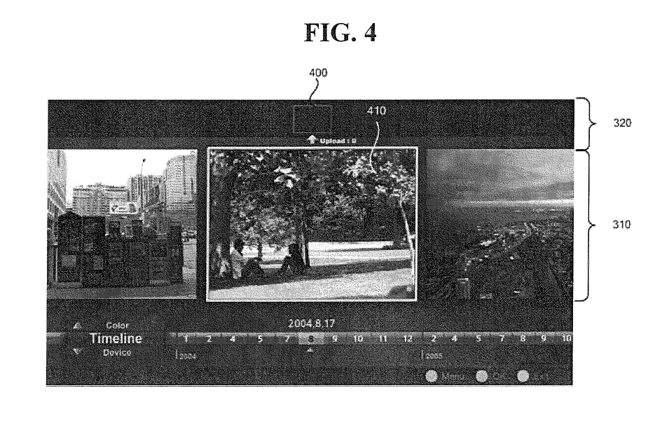

Next, the detailed operation of the multi-selection apparatus according to this embodiment will be described below by reference to FIGS. 4 through 8. FIGS. 4 to 8 are diagrams illustrating a method of inserting a content of a first area into a second area according to the example embodiment of the present invention. As shown in FIG. 4, a plurality of contents (such as 410) is arranged in a line along the horizontal axis in the first area 310. Then, the second area 320 is arranged on the upper side of the first area 310 in parallel to the first area 310. When the user wants to select a predetermined content (or content) 410 from among the contents in the first area 310 in order to insert the content 410 into the second area 320, the user uses a right or left button of the remote controller to search for the content 410 to be inserted. During the search, if the content 410 to be inserted is disposed on the left of the first area 310, the user pushes the left button of the remote controller. Accordingly, the first area 310 is moved to the right so that the content 410 is moved toward the center 300 of the screen. When the content 410 is disposed at the center 300 of the screen, the user pushes the up button of the remote controller to select the content 410 and to insert the selected content 410 into the second area 320. When the content 410 is disposed at the center 300 of the screen and the content 410 does not already exist in the second area 320, a space 400 having a sufficient size to include the content 410 (or a corresponding content 410′) may be formed in the second area 320 and be displayed to the user.

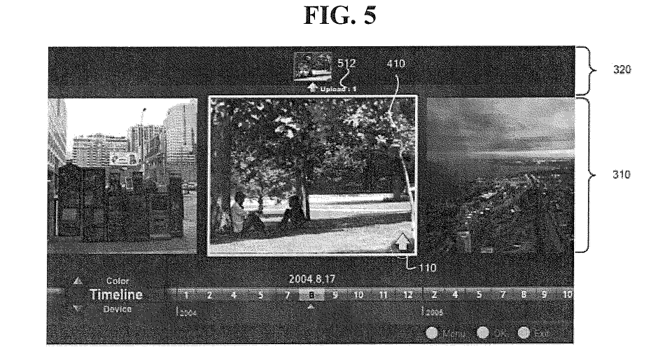

As shown in FIG. 5, the user pushes the up button of the remote controller to insert the content 410 disposed at the center 300 of the screen into the second area 320. Preferably, though not required, the user is not allowed to search the second area 320, unlike the first area 310. However, in other aspects, the second area 320 is allowed to be searched.

In addition, a total number (or a running count) of inserted contents may be displayed in a predetermined part 512 of the second area 320. In various example embodiments, other information may also be displayed in the predetermined part 512, such as a remaining capacity of the second area 320 to accept the contents. Additionally, the predetermined identification mark 110 is displayed in the inserted content 410 so that the inserted content 410 can be discriminated from other contents of the first area 310. After the content 410 is inserted into the second area 320, if the user wants to insert an additional content into the second area 320, the user searches for another content to be inserted from the first area 310 into the second area 320 by using the remote controller again.

To search for another content, the mask window 100 (having a size similar or equal to that of the content in the first area 310) may be provided in the center 300 of the screen in the first area 310. The mask window 100 helps the user to easily check (or determine) whether a predetermined content is arranged exactly at the center 300 of the screen as the first area 310 is moved.

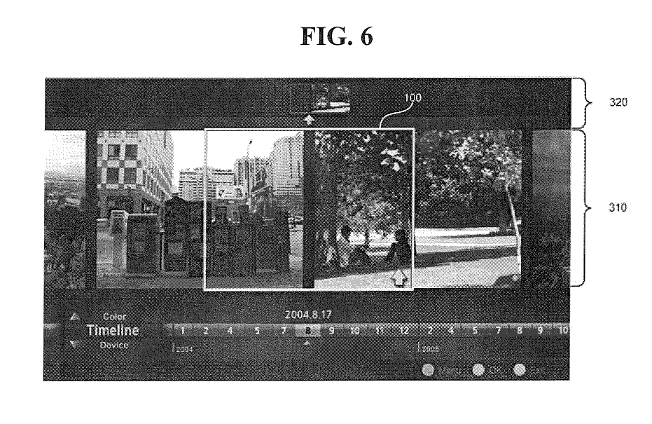

That is, as shown in FIG. 6, if one of the contents is completely included in the mask window 100 during the search of a predetermined (or desired) content within the first area 310, this indicates that the one content is exactly disposed at the center 300 of the screen of the first area 310. However, when one of the contents is not completely included in the mask window 100 during the search of a predetermined content within the first area 310, this indicates that the one content is not exactly disposed at the center 300 of the screen of the first area 310. In an example embodiment, the mask window 100 is fixed relative to the screen. In other example embodiments, the mask window 100 may be moved instead of the first area.

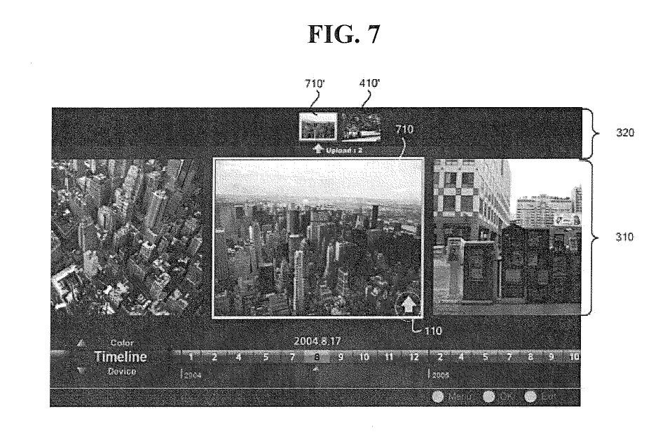

In example embodiments, the second area 320 may be moved together with the first area 310. For example, assume that a content A to be inserted into the second area 320 is disposed on the left of the first area 310, but the content A have not yet been inserted into the second area 320. However, a content B has already been inserted into the second area 320. In this case, when the user clicks the left button of the remote controller to search for the content A, the second area 320 is also moved to the right, so that a space having a sufficient size to include the content A (or a corresponding content thereof) is made in the second area 320. The content A is disposed on the left of the first area 310 relative to the content B, which indicates that the content A (or a corresponding content thereof) is inserted into the second area 320 relative to the content B (or a corresponding content thereof) in the same order or arrangement to that of content A's arrangement relative to the content B in the first area 310. Once a sufficient sized space is formed in the second area 320, as shown in FIG. 7, the user can insert an additional content 710 in a space having the predetermine size in the second area 320 so that a corresponding content 710′ appears or is displayed.

Accordingly, in various example embodiments, the first area 310 is able to have a sequential linear arrangement of contents in a first direction, and a second area 320 running parallel to the first area 310 have a capacity to receive the contents from the first area 310 in a way that is also sequential and linear in arrangement, which is linked or corresponds to the sequential arrangement of contents in the first area 310.

The user can easily check which contents have been inserted into the second area 320. As described above, the predetermined identification mark 110 is displayed in the content 710 of the first area 310 corresponding to the content 710′ inserted into the second area 320, which makes it possible for the user to easily check which of the contents of the first area 310 have been inserted into the second area 320.

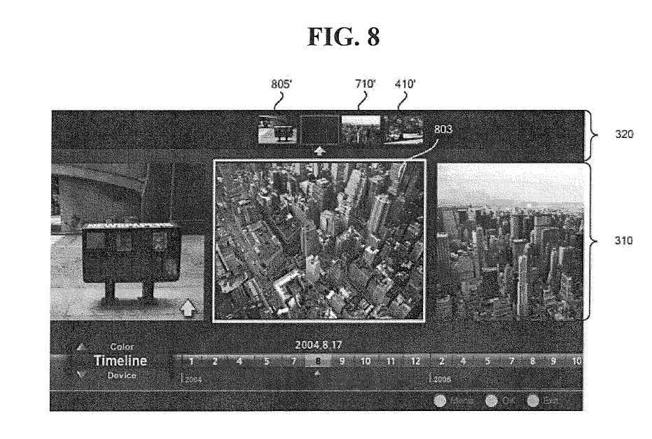

For discussion purposes, assumed that, among several contents referred to as Nos. 1 to 10, content Nos. 2, 4, and 5 have been inserted into the second area 320, and the user wants to additionally insert content No. 3 into the second area 320. In this case, the user uses the left or right button of the remote controller to search for the content No. 3 in the first area 310. When the content No. 3 is disposed at the center 300 of the screen, a space having a sufficient size to include the content No. 3 is automatically formed between the content Nos. 2 and 4 of the second area 320, so that the content Nos. 2 and 4 are separated from each other in the horizontal direction, as shown in FIG. 8.

That is, as shown in FIG. 8, when the content No. 3 (803) is disposed at the center of the screen in the first area 310 and content Nos. 2, 4, and 5 (or corresponding contents 805′, 710′, and 410′) have already been inserted into the second area 320, the content No. 3 (or corresponding content 803′) is arranged after the content No. 2 (805′) and before the content No. 4 (710′). Therefore, the content Nos. 2 and 4 (805′ and 710′) are separated from each other such that the content No. 3 is inserted therebetween. Thus, the user can easily insert the content No. 3 (803) into the second area 320 in the order of arrangement that is existent in the first area 310.

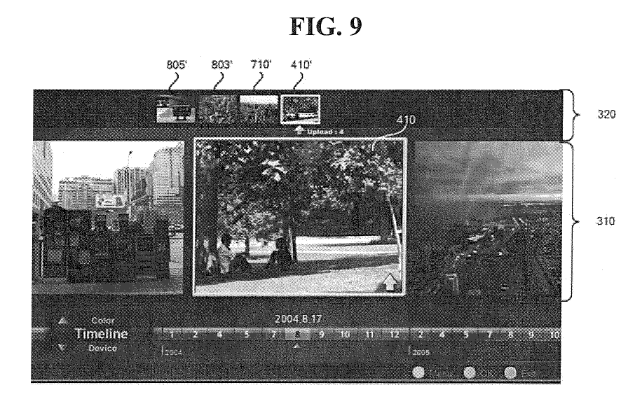

Meanwhile, as shown in FIG. 9, when the user wants to extract the corresponding content 410′ from among the contents that have been inserted into the second area 320, the user searches the inserted content 410 from the first area 310 and disposes the content 410 in the center 300 of the screen. That is, as described above, since the second area 320 is moved (or scrolled) together with the first area 310, the corresponding content 410′ in the second area 320 becomes aligned with to the inserted content 410 disposed in the center 300 of the screen in the first area 310 along the central axis of the screen. Then, the user pushes the down button against the inserted content 410 to extract the corresponding content 410′ from the second area 320.

Once the desired contents are inserted to or extracted from the second area 320, the user can execute a predetermined operation command on the contents in the second area 320. For example, the user can collectively delete, copy, and/or transmit the contents in the second area 320. The operation command may be set and executed before or after the contents are inserted into the second area 320. In other example embodiments, other operation commands may be executed, such as collective insertion or extraction of the contents.

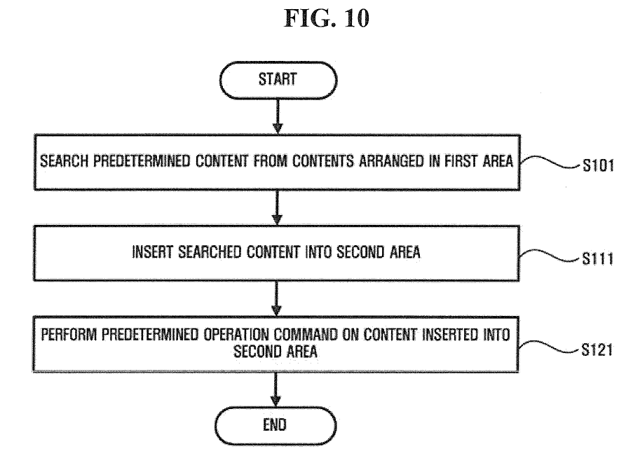

FIG. 10 is a flowchart illustrating a multi-selection method according to an example embodiment of the present invention. As shown in FIG. 10, given the first area 310 (in which a plurality of contents are arranged in a line along a predetermined axis) and the second area 320 (arranged in parallel to the first area 310), the search unit 230 searches for a predetermined content from among the contents arranged in the first area 310 (operation S101).

When the searched for content is disposed at the center 300 of the screen in the first area 310, the moving unit 240 inserts the searched for content into the second area 320 (operation S111). For example, when the user clicks or presses the up button of the remote controller, the moving unit 240 inserts the searched content into the second area 320. On the other hand, the moving unit 240 may extract the contents from the second area 320 by using the same principle. That is, when the user clicks or presses the down button of the remote controller against the searched for content of the first area 310, the moving unit 240 extracts the content in the second area 320 corresponding to the searched for content from the second area 320.

Then, the command unit 250 performs a predetermined operation on the contents that are inserted into the second area 320 (operation S121).

In this way, the user can perform a multi-selection operation in an apparatus, such as a digital TV or a mobile apparatus, by an intuitive and easy interface scheme by using only the directional buttons of the input device. As described above, according the multi-selection apparatus and method according to the above-mentioned embodiments of the invention, it is possible to effectively execute a process of selecting a plurality of contents and a process of performing an operation command through an intuitive and easy interface scheme.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the search unit, the moving unit, and the command unit may be embodied in a single controller. In various example embodiments, variety of buttons or keys may represent the directional buttons. For example, in a mobile phone, one or more of the keypads may represent the directional buttons. Also, in a computer keyboard, any key may represent the directional button. It should be understood that directional buttons, or functional equivalents may be provided for a variety of input devices. Accordingly, it is intended, therefore, that the present invention not be limited to the various example embodiments disclosed, but that the present invention includes all embodiments falling within the scope of the appended claims.

What is claimed is:

1. A multi-selection apparatus comprising:
a display unit to display a first area in which a plurality of contents are arranged in a line along a predetermined axis and a second area arranged in parallel to the first area;
an input unit to receive inputs of user selections;
a search unit to search for at least one of the contents to be inserted from the first area into the second area in response to an input signal, via the input unit;
a moving unit to insert the at least one content searched from the first area into the second area or to extract the content from the second area in response to another input signal, via the input unit; and
a command unit to perform a predetermined operation command on the at least one content inserted into the second area.

2. The multi-selection apparatus of claim 1, wherein if the at least one content to be inserted into the second area is searched from within the first area, the first area is moved, and the second area is also moved according to the movement of the first area.

3. The multi-selection apparatus of claim 1, wherein a space having a sufficient size to include the at least one content selected from the first area is formed in the second area to accommodate the at least one content.

4. The multi-selection apparatus of claim 1, wherein the at least one content inserted into the second area is arranged in the same order as is arranged in the first area.

5. A multi-selection method comprising:
displaying a first area in which a plurality of contents are arranged in a line along a predetermined axis and a second area arranged in parallel to the first area;
receiving inputs of user selections to output corresponding one or more signals;
searching for at least one of the contents to be inserted from the first area into the second area in response to an input signal, via the inputs of user selections;
inserting the at least one content searched from the first area into the second area in response to another input signal, via the inputs of user selections; and
performing a predetermined operation command on the at least one content inserted into the second area.

6. The multi-selection method of claim 5, wherein, if the at least one content to be inserted into the second area is searched from within the first area, the first area is moved, and the second area is also moved according to the movement of the first area.

7. The multi-selection method of claim 5, wherein a space having a sufficient size to include the at least one content selected from the first area is formed in the second area to accommodate the at least one content.

8. The multi-selection method of claim 5, wherein the at least one content inserted into the second area is arranged in the same order as is arranged in the first area.

9. The multi-selection method of claim 5, further comprising:
extracting the at least one content inserted into the second area in response to yet another output signal.

10. An apparatus comprising:
a display to display,
a first area that scrolls along an axis,
one or more contents contained in the first area that scrolls along with the first area, and
a second area running parallel to the first area and having a capacity to receive contents from the first area via a route running along another axis that is normal to the axis; and
a controller to perform one or more operations on the contents received into the second area.

11. The apparatus of claim 10, further comprising one or more corresponding contents in the second area, which respectively correspond to the one or more contents of the first area.

12. The apparatus of claim 11, wherein the one or more contents of the first area includes an indicia that indicates the one or more contents of the first area have respective one or more corresponding contents in the second area.

13. The apparatus of claim 10, wherein the first area and the second area correspondingly scroll along the axis in the same direction.

14. The apparatus of claim 10, wherein the one or more operations include one of copying, deleting, and transmitting.

15. A method of selecting one or more contents using an apparatus to provide a visual display of a first area, a second area, and the one or more contents, comprising:
scrolling the first area along an axis until a desired one of the one or more contents contained in the first area is aligned with a predetermined marker;
inserting a desired one content into the second area via a route running along another axis that is normal to the axis; and
performing one or more operations on the desired one content inserted into the second area.

16. The method of claim 15, wherein the first area and the second area correspondingly scroll along the axis in the same direction.

17. The method of claim 15, wherein the one or more operations include one of copying, deleting, and transmitting.
